(19) United States
(12) Patent Application Publication
(10) Pub. No.: US 2005/0005625 A1
(43) Pub. Date: Jan. 13, 2005

(54) Automatic draining apparatus for condensed water of air conditioner

(76) Inventor: Wan Young Lee, Seoul (KR)

Correspondence Address: SHERIDAN ROSS PC, 1560 BROADWAY, SUITE 1200, DENVER, CO, 80202, US

(21) Appl. No.: 10/804,239

(22) Filed: Mar. 18, 2004

(30) Foreign Application Priority Data
Jul. 9, 2003 (KR) 20-2003-0022031

(51) Int. Cl. F02M 25/00; F25D 21/14

(52) U.S. Cl. 62/285

(57) ABSTRACT

Automatic draining apparatus for condensed water of an air conditioner is comprised of water collecting tank for accumulating condensed water, siphon for draining condensed water contained in the water collecting tank to outside, inlet of the siphon being provided in the water collecting tank and outlet of the siphon being provided at outside, and a level of the outlet being placed at a lower level of the inlet, water supplying pump being connected to the inlet and activated for a while according to a level of the condensed water and supplying the condensed water to the siphon, and water level sensor for operating the water supplying pump when the condensed water level is reached at a maximum level. Further, the water collecting tank is installed in or out of indoors unit of an air conditioner. It can be easily installed and most of the water can be exhausted by a siphon action with non-power, leading the significant reducing operation time of the water discharge pump.

### BACKGROUND OF THE INVENTION

1. Field of the Invention

The present invention is related to an apparatus for automatically draining condensed water formed on an evaporator to the outside during the operation of an air conditioner, and more particularly, to an automatic draining apparatus for the condensed water of an air conditioner by which most of the condensation is drained with non-power by a siphon operation, thus reducing the working time of a drain pump and also for easier installation.

2. Description of the Prior Art

As it is well known, an air conditioner is an apparatus for maintaining properly the indoor temperature using a refrigerating cycle, which is widely used in the world in large, including general homes.

In the refrigerating cycle, low temperature-low pressure vapor refrigerant is compressed by a compressor into high temperature-high pressure vapor, and the vapor is transformed into liquid by heat exchange (i.e. heat release) with outdoor air at a condenser. Liquid refrigerant is expanded through an expansion valve, and low temperature-low pressure refrigerant is evaporated by heat exchange (i.e. endothermic reaction) with indoor air at an evaporator. Therefore, indoor air become cooler.

During the operation, moisture embedded in air is condensed by the temperature difference between an evaporator, in which pressure of saturated vapor is dramatically lowered. Thus, a great quantity of condensed water is formed on the evaporator. The condensed water must be discharged outside owing to the possibility of indoor contamination.

It is, however, hard to choose an installing point for a draining apparatus since users tend to use an air conditioner in a convenient place. Artificial draining methods are commonly adopted in that condensed water is collected in a separate container and the collected water having a predetermined volume is infused into a drain pipe.

It pays close attention that the condensed water does not overflow from a container. Frequent spilling of the collected water accompanies great inconvenience in air conditioner use. These days, a forcible drain method is commonly used in that a drain pipe is connected to a drain pan, which collects condensed water, and a pump discharges the condensed water.

By using the forcible drain, condensed water can be drained easily and precisely. It, however, leads to a problem in that a drain pump must be continuously running during the operation of an air conditioner, causing increased noise of the indoor unit and power consumption.

On the other hand, the present applicant represents an automatic drain apparatus of condensed water using atmospheric pressure as in Korean Utility Model Registration No. 0231674, which was previously registered. In this technology, as condensed water fills in a water-collecting tank to a maximum level, a water-supplying pump runs for a while for the condensed water to feed into a siphon. A siphon action starts when a siphon is filled with condensed water. The siphon action continues owing to a water level control tank provided at an outlet of the siphon. Therefore, the condensed water is spontaneously discharged with no power.

This technology has an advantage in that a water-supplying pump runs at one time during the operation of an air conditioner. A water level control tank, however, must be accurately installed at the predetermined level point which is relative to the water level of a water-supplying tank. This installation is very difficult and it is hard to anticipate the precise installation.

Even after an installation of the cited apparatus is made, when an external force is applied to the exposed siphon, the level of a water level control tank is out of position and the siphon action is not accomplished smoothly.

In other words, a siphon action can be achieved continuously in case that the water level control tank is provided at the same level as the water collecting tank and the level of an outlet of the siphon immersed in the water level control tank is placed at a lower level than the inlet of the drain pipe. It, however, is very difficult to get an accurate installation even by a skilled worker. Even after an installation, as an external force is applied to an exposed siphon, making a deformation, the level of the water level control tank is out of position. It is difficult to expect a continuous siphon action.

Furthermore, in the above case, condensed water must be maintained at a predetermined level in the water collecting tank and the water level control tank. No discharge could be accomplished if condensed water does not flow out from the air conditioner. More, discharge of a foreign substance such as dust etc. is not easy since the discharge velocity is very slow, which is influenced by the velocity of the condensed water. It, therefore, may be very possible that if an air conditioner is not operated for a long period of time, moss can grow in the water collecting tank and it will become contaminated with germs.

### SUMMARY OF THE INVENTION

It is an object of the present invention to provide an automatic draining apparatus for condensed water of an air conditioner in which most of the water can be exhausted by a siphon action with non-power, leading the significant reducing operation time of the water discharge pump and an easy installation of the draining apparatus for condensed water and siphon action can be maintained without influence of exterior force, even after the installation of the draining apparatus.

It is a further object of the present invention to provide an automatic draining apparatus for condensed water of an air conditioner in which condensed water contained in a water collecting tank is rapidly discharged and also any foreign substance such as dust etc. can be easily discharged and thus any foreign substance residue in the water collecting tank can be reduced.

In order to accomplish those and these objects, it has characteristic in that the present invention is comprised of water collecting tank for catching condensed water formed on an evaporator of an air conditioner, siphon for draining condensed water contained in the water collecting tank to outside, inlet of the siphon being provided in the water collecting tank and outlet of the siphon being provided at outside, and a level of the outlet placing at a lower level of the inlet, water supplying pump being connected to the inlet of the siphon and activated for a time according to a level of the condensed water and supplying the condensed water of the water collecting tank to the siphon, and water level sensor for operating the water supplying pump when the condensed water level of the water collecting tank is reached at a maximum level.

Further, it has another characteristic in that the water collecting tank is installed in indoors unit of an air conditioner.

According to the present invention, it can be easily installed and most of the condensed water can be exhausted by siphon action with non-power, and it leads to a significant reduction of operation time of the water discharge pump. Further, the condensed water can be rapidly discharged. Therefore, the present invention has superior advantages in the areas of reliability, execution and convenience to use.

### BRIEF DESCRIPTION OF DRAWINGS

The above and other objects, features and other advantages of the present invention will be more clearly understood from the following detailed description taken in conjunction with the accompanying drawings, in which:

FIG. 1 is a side elevational sectional view illustrating an automatic draining apparatus for condensed water of an air conditioner provided in an indoor unit according to the present invention; and

FIG. 2 is a side elevational sectional view of an automatic draining apparatus for condensed water of an air conditioner provided at outside of an indoor unit according to the present invention.

### DETAILED DESCRIPTION OF THE PREFERRED EMBODIMENTS

This invention will be described further by way of exemplary embodiments with reference to the accompanying drawings.

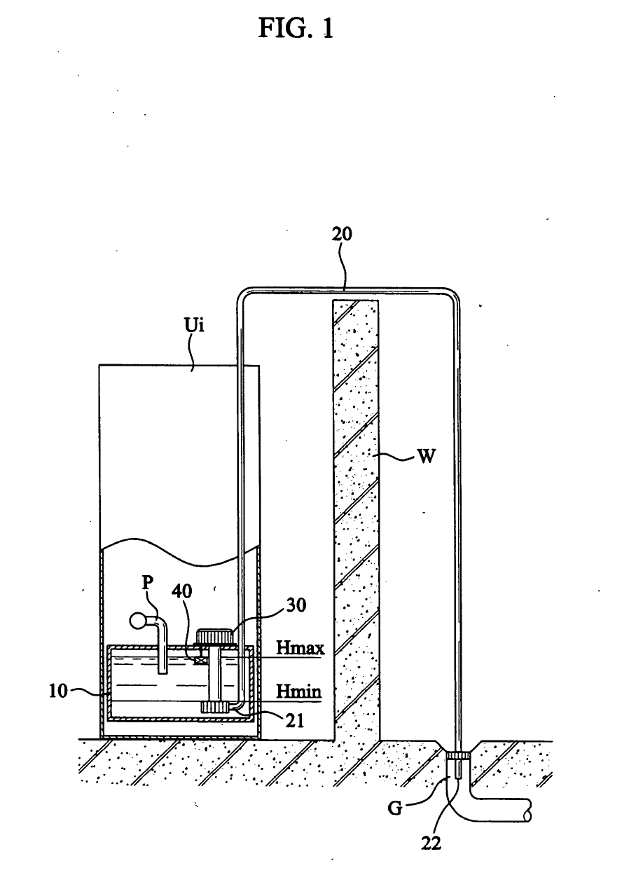

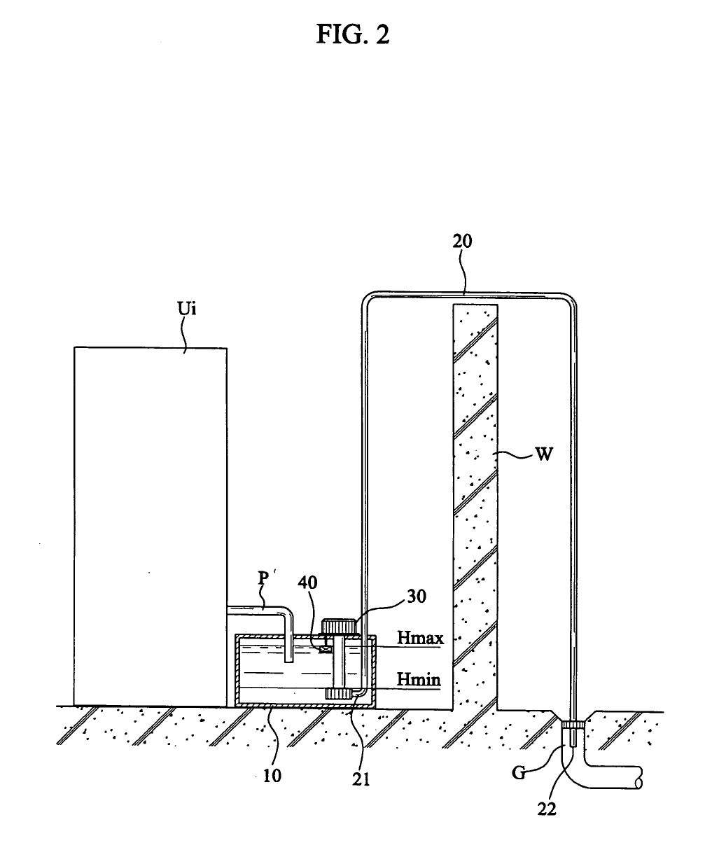

As shown in FIGS. 1 and 2, an automatic draining apparatus for condensed water of an air conditioner comprises a water collecting tank 10 for collecting condensed water formed on an evaporator (not shown) of an indoor unit “Ui”, a siphon 20 for draining condensed water contained in the water collecting tank 10 to the outside by a siphon operation, a water supplying pump 30 for supplying the condensed water of the water collecting tank 10 to the siphon 20, and a water level sensor 40 for operating the water supplying pump 30 for a time depending on the level of the condensed water of the water collecting tank 10.

The water collecting tank 10 has a depth, which can collect condensed water of a specific level in order for a siphon operation to occur. The water collecting tank 10 may be installed at any location, inside or outside of the indoor unit “Ui”, but considering the appearance of the interior, as shown in FIG. 1, the water collecting tank 10 can be installed inside of the indoor unit “Ui” and be connected with a condensed water drain pipe “P” provided at a drain pan (not shown).

On the other hand, as shown in FIG. 2, in the case that the water collecting tank 10 can be installed outside of the indoor unit “Ui”, the drain pipe “P” passes through a cabinet of the indoor unit “Ui” in order to be properly extended outward.

The siphon 20 is bent in the shape of an inverse “U” and climbs above a wall “W” or passes through a wall “W”. An inlet 21 of the siphon 20 is placed at a predetermined depth in the water collecting tank 10 of the inside. An outlet 22 is located at the lower level than the inlet 21 in order to execute a siphon operation. It is allowable that the outlet 22 is left alone, but the outlet 22 could be extended into a drain hole “G” provided at outside.

The water supplying pump 30 is installed in the water collecting tank 10 and is connected to the inlet 21 of the siphon 20. The water supplying pump 30 works for a time when the condensed water fills in the water collecting tank 10 to a predetermined maximum level “Hₘₐₓ”. Since the siphon has to be fully filled with the condensed water in order for the siphon operation to occur, the water supplying pump 30 runs for a predetermined short period, when the condensed water is filled in the siphon 20, to start the siphon operation.

Therefore, electric power consumption for the water supplying pump 30 is very slight. The water supplying pump 30 can be connected to alternative current supplied from an outside power source or can use a built-in battery.

The water level sensor 40 is installed at the water supplying pump 30 to detect the level of the condensed water being filled in the water collecting tank 10. A signal generated from the water level sensor 40 when level reaches max is sent to a controller of the water supplying pump 30 so that the water supplying pump starts running.

The operation of the automatic draining apparatus for condensed water of an air conditioner will now be explained with reference to the attached drawings.

During the off operation of an air conditioner, there is no condensed water in the water collecting tank 10, or the condensed water exists at a minimum level “Hₘᵢₙ”. The inside of the water collecting tank 10 maintains a predetermined space. Thus, the inside of the siphon 20 is empty.

In the above state, when an operation of an air conditioner starts, the condensed water formed on evaporator flows into the water collecting tank 10 through the drain pipe “P” installed at a drain pan. As the condensed water fills till the maximum level “Hₘₐₓ” of the water collecting tank 10, the water level sensor 40 detects it and a signal is sent to the water supplying pump 30.

The water supplying pump 30 starts running for a while, and the condensed water in the water collecting tank 10 is pushed to the siphon 20. Therefore, condensed water fills in the siphon 20. Thereafter, the condensed water is vented from the outlet 22 and the siphon action commences. The condensed water level becomes slightly lower than the maximum level “Hₘₐₓ” owing to the siphon action. Finally, the operation of the water supplying pump 30 is suspended.

Regardless of the suspended running, condensed water is exhausted continuously to the outside with non-power by the siphonic action until the condensed water level of the water collecting tank 10 reaches the minimum level “Hₘᵢₙ”. However, condensed water flows in the water collecting tank 10 from an evaporator while the condensation water of the water collecting tank 10 has been exhausted. Since the outflow volume is greater than inflow volume relatively, the water level of the water collecting tank 10 is lowering gradually and reaches the minimum level “Hₘᵢₙ”.

Condensed water is exhausted promptly irrespective of inflow speed of condensed water formed on an evaporator. Thus, a foreign substance such as dust etc. contained in a condensed water is discharged certainly to the outside along with a condensed water.

As the water level lowers to a minimum level “Hₘᵢₙ”, the air of the water collecting tank 10 comes in the siphon 20, and the siphon action is suspended to stop the exhaustion of the condensed water. Then the inside of the siphon 20 is empty again.

As time goes by in the above state, condensed water flows in the water collecting tank 10 to reach the maximum level “Hₘₐₓ”. As described above, after the water level sensor 40 detects the water height, the operation of the water supplying pump 30 resumes for a while. Thus, the siphon action begins to exhaust condensed water. The above procedure recurs during all operations of the air conditioner.

Though no more condensed water flows in the water collecting tank 10 during non-operation of an air conditioner, the siphon action, which has already started, can not be stopped. Thus, the water discharge action continues until the level of condensed water reaches the minimum level “Hₘᵢₙ”.

According to the present invention, the water supplying pump operates intermittently for a predetermined time when the siphon is filled with the condensed water. Most of the condensed water can be exhausted by siphon action with non-power. That leads to a significant reduction of operation time of the water discharge pump. And also, it contributes to the lower operation noise and less consumption of power of an air conditioner.

Since no water level maintaining tank is required, which maintains continuously a siphon action, the draining apparatus for condensed water can be easily installed. There is no concern of a hindrance to the siphon action by exterior force, even after the installation of the draining apparatus.

Further, rapid discharge of the condensed water contained in the water-collecting tank brings the easy exhaustion of all foreign substances such as dust etc. and a reduction of foreign substance residue in the water-collecting tank.

Therefore, the present invention has superior advantages in the areas of reliability, convenience and easier installation of an air conditioner.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An automatic draining apparatus of condensed water of air conditioner comprising:
water collecting tank for catching condensed water formed on an evaporator of an air conditioner;
siphon for draining condensed water contained in the water collecting tank to outside, inlet of the siphon being provided in the water collecting tank and outlet of the siphon being provided at outside, and a level of the outlet placed at a lower level of the inlet;
water supplying pump being connected to the inlet of the siphon and activated for a while according to a level of the condensed water and supplying the condensed water of the water collecting tank to the siphon; and
water level sensor for operating the water supplying pump when the condensed water level of the water collecting tank is reached at a maximum level.

2. An automatic draining apparatus of condensed water of air conditioner according to claim 1, wherein the water collecting tank is installed in indoors unit of an air conditioner.
